(19) United States
(12) Patent Application Publication
(10) Pub. No.: US 2024/0037902 A1
(43) Pub. Date: Feb. 1, 2024

(54) INFERENCE METHOD AND INFORMATION PROCESSING APPARATUS

(71) Applicant: Fujitsu Limited, Kawasaki-shi (JP)

(72) Inventors: Takanori NAKAO, Kawasaki (JP); Xuying LEI, Kawasaki (JP)

(73) Assignee: Fujitsu Limited, Kawasaki-shi (JP)

(21) Appl. No.: 18/297,039

(22) Filed: Apr. 7, 2023

(30) Foreign Application Priority Data
Jul. 26, 2022 (JP) 2022-118759

(51) Int. Cl. G06V 10/70; G06T 5/00; G06V 10/25; G06V 10/44

(52) U.S. Cl. CPC G06V 10/70; G06T 5/006; G06V 10/25; G06V 10/44; G06V 2201/07

(57) ABSTRACT

An information processing apparatus obtains first feature data generated from image data including a plurality of pixels given different first coordinates, the first feature data including a plurality of feature values given different second coordinates. The information processing apparatus generates a first inference result indicating an image region of the image data by feeding the first feature data to a first machine learning model. The information processing apparatus generates second feature data corresponding to the image region from the first feature data on the basis of coordinate mapping information indicating mapping between the first coordinates and the second coordinates. The information processing apparatus generates a second inference result for the image region by feeding the second feature data to a second machine learning model.

### CROSS-REFERENCE TO RELATED APPLICATION

This application is based upon and claims the benefit of priority of the prior Japanese Patent Application No. 2022-118759, filed on Jul. 26, 2022, the entire contents of which are incorporated herein by reference.

### FIELD

The embodiments discussed herein relate to an inference method and an information processing apparatus.

### BACKGROUND

An information processing apparatus may be used to perform image recognition using a machine learning model. For example, the machine learning model is a neural network trained by deep learning. A machine learning model may receive image data, transform the received image data to feature data including a plurality of feature values, and infer an image region including a specified object in the image data on the basis of the feature data. In addition, another machine learning model may receive image data representing an object, transform the received image data to feature data including a plurality of feature values, and infer the class of the object on the basis of the feature data.

In this connection, there has been proposed an information processing apparatus that trains, by semi-supervised learning using training data, an image recognition model that includes a feature value extractor of extracting feature values from image data received and a discriminator of transforming the extracted feature values to discrimination values for use in object recognition.

Please see, for example, Japanese Laid-open Patent Publication No. 2019-207561.

### SUMMARY

According to one aspect, there is provided a non-transitory computer-readable storage medium storing a computer program that causes a computer to perform a process including: obtaining first feature data generated from image data including a plurality of pixels given different first coordinates, the first feature data including a plurality of feature values given different second coordinates; generating a first inference result indicating a partial image region of the image data by feeding the first feature data to a first machine learning model; generating second feature data corresponding to the partial image region indicated by the first inference result, from the first feature data, based on coordinate mapping information indicating mapping between the different first coordinates and the different second coordinates; and generating a second inference result for the partial image region by feeding the second feature data to a second machine learning model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for describing an information processing apparatus according to a first embodiment;

FIG. 2 illustrates an example of an information processing system according to a second embodiment;

FIG. 3 is a block diagram illustrating an example of the hardware configuration of a server apparatus;

FIG. 4 illustrates an example of image data obtained by a surveillance camera;

FIG. 5 illustrates an example of combining a plurality of image recognition models;

FIG. 6 illustrates an example of using an early-stage model in common;

FIG. 7 illustrates an example of a coordinate transformation function;

FIG. 8 illustrates an example of data transformation in a pooling layer;

FIG. 9 illustrates an example of data transformation in a convolutional layer;

FIG. 10 illustrates an example of rearranging image blocks;

FIG. 11 illustrates an example of the structure of an early-stage model;

FIG. 12 illustrates an example of the structure of a later-stage model;

FIG. 13 is a block diagram illustrating an example of the functions of server apparatuses;

FIG. 14 illustrates an example of machine learning data;

FIG. 15 is a flowchart illustrating an example of a machine learning procedure; and

FIG. 16 is a flowchart illustrating an example of an image recognition procedure.

### DESCRIPTION OF EMBODIMENTS

There is a case where an information processing apparatus uses a machine learning model to perform an inference process to specify a partial image region of image data and then uses a different machine learning model to perform a different inference process on the specified partial image region. Here, even machine learning models that are used for different inference purposes may have the same model structure for the first-half process of extracting feature values from image data.

However, the above two machine learning models process image data of different image regions. Therefore, feature data generated by the former inference process is not usable as it is in the latter inference process, and the two machine learning models extract feature values from image data in duplicate.

Embodiments will be described with reference to the accompanying drawings.

### First Embodiment

A first embodiment will be described.

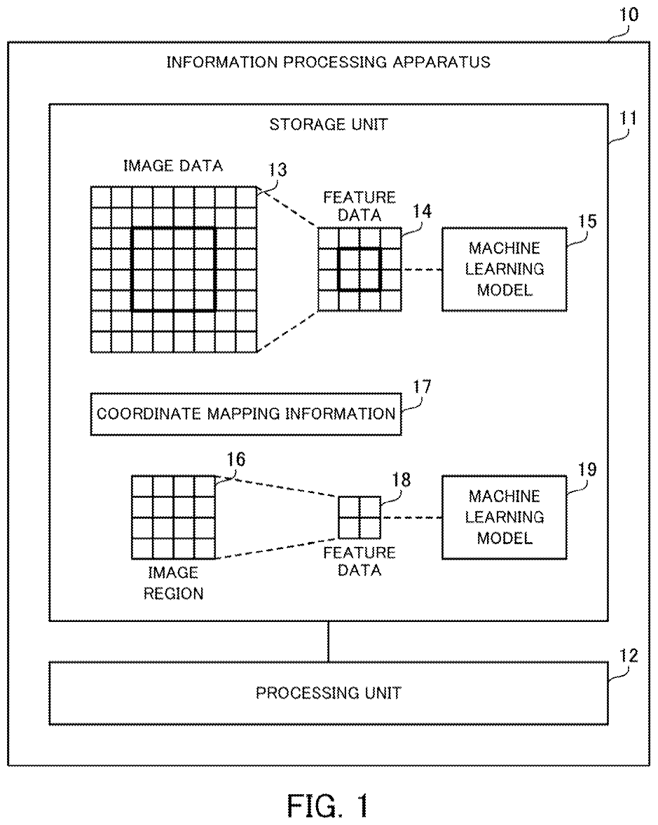

FIG. 1 is a view for describing an information processing apparatus according to the first embodiment.

An information processing apparatus 10 of the first embodiment performs image recognition using machine learning models. The information processing apparatus 10 uses a machine learning model to perform an inference process to specify a partial image region of image data, and then uses a different machine learning model to perform a different inference process on the specified image region. The information processing apparatus 10 may be a client apparatus or a server apparatus. The information processing apparatus 10 may be called a computer or an inference apparatus.

The information processing apparatus 10 includes a storage unit 11 and a processing unit 12. The storage unit 11 may be a volatile semiconductor memory device such as a random access memory (RAN), or a non-volatile storage device such as a hard disk drive (HDD) or a flash memory. The processing unit 12 is a processor such as a central processing unit (CPU), a graphics processing unit (GPU), or a digital signal processor (DSP), for example. In this connection, the processing unit 12 may include an electronic circuit such as an application specific integrated circuit (ASIC) or a field programmable gate array (FPGA). The processor executes programs stored in a memory (e.g., the storage unit 11) such as RAM, for example. A set of processors may be called a multiprocessor, or simply a “processor.”

The storage unit 11 stores therein feature data 14 and coordinate mapping information 17. The feature data 14 is generated from image data 13. The image data 13 includes a plurality of pixels given different first coordinates. The image data 13 is tensor data in which a plurality of pixels are arranged in a rectangular array. The image data 13 may include two or more channels in the depth direction. The first coordinates are coordinates of a rectangular coordinate system with row numbers and column numbers. The image data 13 may be data that is periodically generated, such as a moving image or images captured by a surveillance camera.

The feature data 14 includes a plurality of feature values given different second coordinates. For example, the feature data 14 is tensor data in which a plurality of feature values are arranged in a rectangular array. The feature data 14 may include two or more channels in the depth direction. For example, the second coordinates are coordinates of a rectangular coordinate system with row numbers and column numbers. The feature data 14 may be data that is periodically generated according to changes of the image data 13. For example, the feature data 14 is generated from the image data 13 using a machine learning model. The machine learning model may be a neural network. The transformation from the image data 13 to the feature data 14 may be performed by the information processing apparatus 10 or another information processing apparatus.

The coordinate mapping information 17 indicates the mapping between the first coordinates identifying the pixels of the image data 13 and the second coordinates identifying the feature values of the feature data 14. In the case where the image data 13 is greater than the feature data 14, the first coordinates and the second coordinates have many-to-one mapping relationship. This means that one first coordinate is not mapped to two or more second coordinates. A feature value at a second coordinate corresponding to first coordinates is computed using the pixels specified by the first coordinates. At least one of the pixels included in the image data 13 is used for the computation of a feature value. Two or more pixels that are used for the computation of a feature value may preferably be adjacent to one another in the image data 13.

In the case where a neural network generates the feature data 14, the neural network may include convolutional layers and pooling layers, but preferably does not include a fully-connected layer. The image data 13 may be similar to the feature data 14. The machine learning model of generating the feature data 14 may keep the relative positions of the pixels and feature values. For example, in the case where a first pixel is located above a second pixel, a first feature value computed from the first pixel is located above a second feature value computed from the second pixel. In the case where the first pixel is located on the left side of the second pixel, the first feature value is located on the left side of the second feature value. In this case, the second coordinate is computed by multiplying the first coordinate by a constant value.

Note that the machine learning model may rearrange the pixels or the feature values. In this case, a second coordinate corresponding to a first coordinate is not obtained by multiplying the first coordinate by a constant value. The coordinate mapping information 17 may be generated by a user or may be automatically generated by analyzing the model structure of the machine learning model. The coordinate mapping information 17 may be supplied to the information processing apparatus 10 by the user or may be sent thereto from another information processing apparatus. The other information processing apparatus may be an information processing apparatus that generates the feature data 14.

The processing unit 12 receives the feature data 14, and feeds the feature data 14 to a machine learning model 15 to thereby generate a first inference result. The machine learning model 15 performs a first inference process on the image data 13. For example, the machine learning model 15 has been trained using training data. The machine learning model 15 may be trained by the information processing apparatus 10 or another information processing apparatus. With respect to the first inference process, a machine learning model of generating the feature data 14 corresponds to an early-stage model, and the machine learning model 15 corresponds to a later-stage model.

The first inference process includes specifying an image region 16 that is a partial image region of the image data 13. The first inference result indicates at least the image region 16. For example, the machine learning model 15 detects an image region including a specified type of object in the image data 13. The machine learning model 15 may be a convolutional neural network.

The processing unit 12 generates feature data 18 corresponding to the image region 16 indicated by the first inference result, from the feature data 14 on the basis of the coordinate mapping information 17. For example, the processing unit 12 specifies second coordinates corresponding to the first coordinates given to the pixels included in the image region 16, and extracts feature values given the specified second coordinates from the feature data 14. For example, the feature data 18 is tensor data in which the feature values extracted from the feature data 14 are arranged in a rectangular array. The feature data 18 may be obtained by extracting a partial region from the feature data 14. The feature data 18 may include two or more channels in the depth direction. In this connection, the processing unit 12 may process the feature data 18 so as to match the input format of a machine learning model 19.

The processing unit 12 feeds the feature data 18 to the machine learning model 19 to thereby generate a second inference result. The machine learning model 19 performs a second inference process on the image region 16. For example, the machine learning model 19 has been trained using training data. For example, the machine learning model 19 may be trained by the information processing apparatus 10 or another information processing apparatus. With respect to the second inference process, a machine learning model of generating the feature data 14 corresponds to the early-stage model, whereas the machine learning model 19 corresponds to a later-stage model. In this case, the first inference process and the second inference process share the early-stage model in order to reuse the feature data 14.

The second inference process is performed on the image region 16 that is part of the image data 13. The second inference result indicates a result of the second inference process. For example, the machine learning model 19 determines the state of an object appearing in the image region 16. For example, the machine learning model 15 detects an image region including a human in the image data 13, and then the machine learning model 19 determines the pose of the human. The machine learning model 19 may be a convolutional neural network. The processing unit 12 outputs the second inference result. The processing unit 12 may store the second inference result in a non-volatile storage device, may display it on a display device, or may send it to another information processing apparatus.

As described above, the information processing apparatus 10 of the first embodiment feeds the feature data 14 generated from the image data 13 to the machine learning model 15 to thereby generate a first inference result indicating the image region 16 of the image data 13. The information processing apparatus 10 generates the feature data 18 corresponding to the image region 16 from the feature data 14 on the basis of the coordinate mapping information 17 indicating the mapping between the coordinates of the image data 13 and the coordinates of the feature data 14. The information processing apparatus 10 feeds the feature data 18 to the machine learning model 19 to thereby generate a second inference result for the image region 16.

In the manner described above, the inference processes with different inference purposes are performed on the image data 13. In addition, with the use of the coordinate mapping information 17, the second inference process is able to reuse part of the feature data 14 used in the first inference process. Thus, the feature extraction for generating the feature data 18 from the image region 16 is omitted. This reduces the computational complexity of the plurality of inference processes that process different image regions, and accordingly reduces the load of the information processing apparatus 10.

In this connection, the feature data 14 may be generated by feeding the image data 13 to a machine learning model. This allows the first inference process and the second inference process to share the early-stage machine learning model that performs feature extraction, and eliminates overlapping feature extraction. In addition, the feature data 18 may be generated by extracting feature values given the second coordinates corresponding to the image region 16 from the feature data 14. This approach makes it possible to efficiently reproduce the feature values, which are otherwise normally computed by performing feature extraction on the image region 16.

In addition, the machine learning model 15 may be designed to infer an image region including an object that is a detection target, and the machine learning model 19 may be designed to infer the state of the detected object. These machine learning models 15 and 19 are combined together so as to perform inference processes with different inference purposes on the image data 13 efficiently.

### Second Embodiment

A second embodiment will now be described.

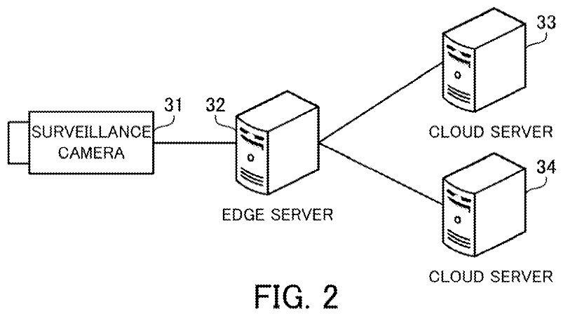

FIG. 2 illustrates an example of an information processing system according to the second embodiment.

The information processing system of the second embodiment analyzes an image captured by a surveillance camera 31 to detect a suspicious human. The information processing system includes the surveillance camera 31, an edge server 32, and cloud servers 33 and 34. The surveillance camera 31 and edge server 32 communicate with each other over a local area network (LAN) or a wide area network. The edge server 32 communicates with the cloud servers 33 and 34 over a wide area network such as the Internet. The cloud server 33 corresponds to the information processing apparatus 10 of the first embodiment.

The surveillance camera 31 is an imaging device that generates image data at a fixed frame rate. For example, the surveillance camera 31 is installed on a street, and continuously sends image data to the edge server 32 over the network.

The edge server 32 is a server computer that is installed closer to the surveillance camera 31 than the cloud servers 33 and 34. The edge server 32 continuously receives image data from the surveillance camera 31. The edge server 32 performs an early-stage process, which will be described later, on the received image data and sends the result of the early-stage process to the cloud server 33 over the network. In this connection, the edge server 32 may send the result of the early-stage process to the cloud server 34, and may use the cloud servers 33 and 34 in parallel.

The cloud servers 33 and 34 are server computers that are installed farther from the surveillance camera 31 than the edge server 32. The cloud servers 33 and 34 provide higher computing power than the edge server 32. The cloud servers 33 and 34 are computing resources that are included in a so-called cloud system, or may be installed in a data center. The cloud servers 33 and 34 may be installed at different locations or may belong to different cloud systems.

The cloud server 33 continuously receives the result of the early-stage process from the edge server 32. The cloud server 33 performs a later-stage process, which will be described later, on the received result of the early-stage process. The later-stage process includes a process of detecting a human in image data and a process of estimating the pose of the detected human. The cloud server 33 outputs the result of the later-stage process. For example, when detecting a human with suspicious behavior, the cloud server 33 sends a notification about the detection of the suspicious human to a client computer used by an operator.

The cloud server 34 may receive the result of the early-stage process from the edge server 32, as with the cloud server 33, and may perform a later-stage process with a different purpose from that of the cloud server 33 in parallel to the cloud server 33. In this connection, the cloud server 34 may be used to train the machine learning models for use in the early-stage process and the later-stage process, as will be described later.

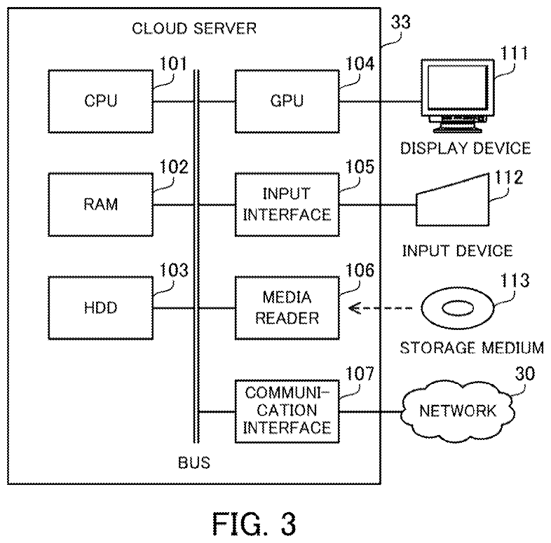

FIG. 3 is a block diagram illustrating an example of the hardware configuration of a server apparatus.

The cloud server 33 includes a CPU 101, a RAM 102, an HDD 103, a GPU 104, an input interface 105, a media reader 106, and a communication interface 107. These hardware units are connected to a bus. The CPU 101 corresponds to the processing unit 12 of the first embodiment. The RAM 102 or the HDD 103 corresponds to the storage unit 11 of the first embodiment. The edge server 32 and cloud server 34 may have the same hardware configuration as the cloud server 33.

The CPU 101 is a processor that executes program instructions. The CPU 101 loads a program and data from the HDD 103 to the RAM 102 and executes the program. The cloud server 33 may include a plurality of processors.

The RAM 102 is a volatile semiconductor memory device that temporarily stores therein programs to be executed by the CPU 101 and data to be used by the CPU 101 in processing. The cloud server 33 may include a different type of volatile memory device than RAM.

The HDD 103 is a non-volatile storage device that stores therein software programs such as an operating system (OS), middleware, and application software, and data. The cloud server 33 may include another type of non-volatile storage device such as a flash memory or a solid state drive (SSD).

The GPU 104 performs image processing in conjunction with the CPU 101 and outputs images to a display device 111 connected to the cloud server 33. Examples of the display device 111 include a cathode ray tube (CRT) display, a liquid crystal display, an organic electro-luminescence (EL) display, and a projector. Another type of output device such as a printer may be connected to the cloud server 33. In addition, the GPU 104 may be used as a general purpose computing on graphics processing unit (GPGPU). The GPU 104 is able to run programs in accordance with commands from the CPU 101. The cloud server 33 may include a volatile semiconductor memory device other than the RAM 102 as a GPU memory.

The input interface 105 receives an input signal from an input device 112 connected to the cloud server 33. Examples of the input device 112 include a mouse, a touch panel, and a keyboard. Plural types of input devices may be connected to the cloud server 33.

The media reader 106 is a reading device that reads programs and data from a storage medium 113. Examples of the storage medium 113 include a magnetic disk, an optical disc, and a semiconductor memory. Magnetic disks include flexible disks (FDs) and HDDs. Optical discs include compact discs (CDs) and digital versatile discs (DVDs). The media reader 106 copies a program and data read from the storage medium 113 to the RAM 102, HDD 103, or another storage medium. The read program may be run by the CPU 101.

The storage medium 113 may be a portable storage medium and may be used for distribution of programs and data. In addition, the storage medium 113 and HDD 103 may be called computer-readable storage media.

The communication interface 107 communicates with the edge server 32 over a network 30. The communication interface 107 may be a wired communication interface that is connected to a switch, a router, or another wired communication device, or may be a wireless communication interface that is connected to a base station, an access point, or another wireless communication device.

The following describes how to perform human detection and pose estimation using machine learning models.

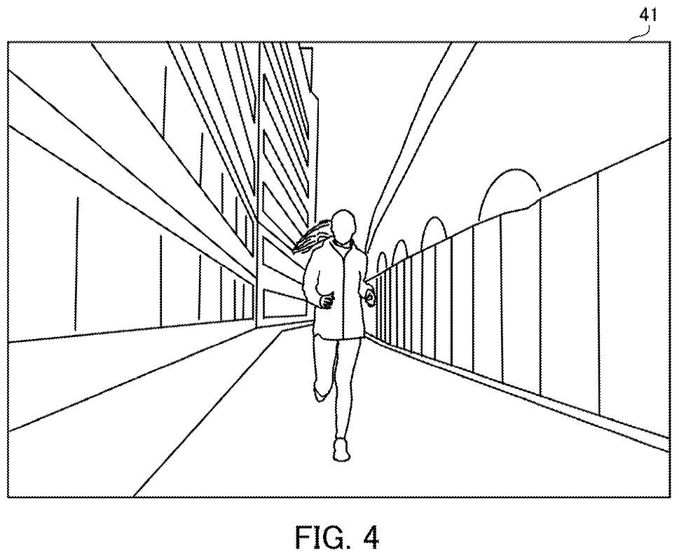

FIG. 4 illustrates an example of image data obtained by a surveillance camera.

The surveillance camera 31 continuously sends image data like image data 41 to the edge server 32. The image data 41 may be a single-channel monochrome image or a three-channel color image. The surveillance camera 31 captures images of a street from a fixed position. A running human appears in an image region at the center of the image data 41. Like this, a human may appear in a partial image region of image data generated by the surveillance camera 31.

The cloud server 33 uses a machine learning model to perform human detection to specify an image region including a human in image data. In addition, the cloud server 33 uses a machine learning model different from that used for the human detection, to perform pose estimation of estimating the pose of the human included in the specified image region. Poses are classified into pose classes including standing, walking, running, sitting, crouching, and others, for example. The following describes a simple implementation example of the above two machine learning models.

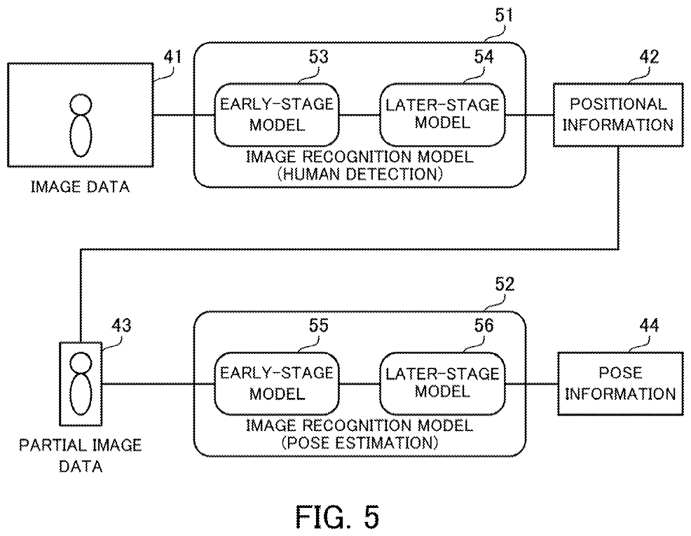

FIG. 5 illustrates an example of combining a plurality of image recognition models.

An image recognition model 51 is a machine learning model for the human detection. An image recognition model 52 is a machine learning model for the pose estimation. The image recognition models 51 and 52 are convolutional neural networks with convolutional layers and pooling layers.

The image recognition model 51 receives the image data 41. The image recognition model 51 processes the image data 41 and outputs positional information 42. The positional information 42 indicates one or more image regions each including a human in the image data 41. For example, the positional information 42 includes the upper left coordinate and lower right coordinate of a rectangular bounding box indicating an image region.

The image recognition model 51 includes an early-stage model 53 and a later-stage model 54. The early-stage model 53 computes feature values from the pixel values included in the image data 41 and generates a feature map in which the computed feature values are arranged in a grid. The later-stage model 54 detects an image region including a human on the basis of the feature map generated by the early-stage model 53. For example, with respect to a plurality of bounding box candidates, the later-stage model 54 computes the probability of human existence for each bounding box candidate. The later-stage model 54 then outputs the coordinates of a bounding box whose probability exceeds a threshold, as the positional information 42.

When the positional information 42 has been generated, an image region indicated by the positional information 42 is extracted from the image data 41, thereby generating partial image data 43 including a human. The image recognition model 52 receives the partial image data 43. The image recognition model 52 processes the partial image data 43 to generate pose information 44. The pose information 44 indicates the pose of the human included in the partial image data 43. For example, there are a plurality of pose classes, and the pose information 44 includes the probability of each pose class. Alternatively, for example, the pose information 44 includes a pose class with the highest probability and its probability.

The image recognition model 52 includes an early-stage model 55 and a later-stage model 56. The early-stage model 55 computes feature values from the pixel values included in the partial image data 43 and generates a feature map in which the computed feature values are arranged in a grid. The later-stage model 56 estimates the pose of the human included in the partial image data 43 on the basis of the feature map generated by the early-stage model 55. For example, the later-stage model 56 computes the probability of each of the plurality of pose classes, and classifies the partial image data 43 into a pose class based on the highest probability. The pose classes indicate human poses such as standing, walking, running, sitting, and crouching. The later-stage model 56 recognizes the human parts including head, hands, arms, legs, and feet included in the partial image data 43 to estimate a pose.

By the way, both the early-stage model 53 for the human detection and the early-stage model 55 for the pose estimation perform a process of computing feature values from a set of pixel values in common, and therefore may have the same model structure. Since the partial image data 43 is part of the image data 41, the early-stage model 53 may perform the same feature extraction as the early-stage model 55. However, the early-stage model 53 and early-stage model 55 process different image regions, and therefore output different feature maps. For this reason, the later-stage model 56 is not able to reuse an output of the early-stage model 53 as it is.

To deal with this, the information processing system of the second embodiment employs a coordinate transformation function to transform the feature map generated by the early-stage model 53 to a feature map to be input to the later-stage model 56. The information processing system integrates the early-stage models 53 and 55 in order to reuse a feature map generated in the human detection, for the pose estimation. By doing so, the feature extraction of the early-stage model 55 is omitted.

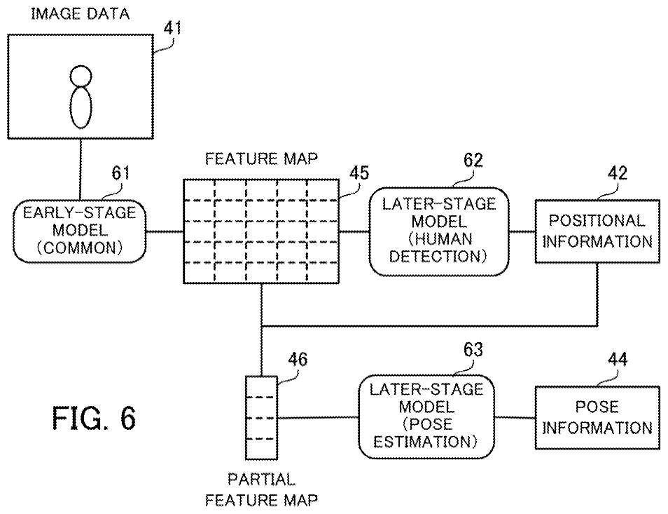

FIG. 6 illustrates an example of using an early-stage model in common.

An early-stage model 61 is a machine learning model for the feature extraction, which is used in common in the human detection and the pose estimation. The early-stage model 61 is a convolutional neural network with convolutional layers and pooling layers. The early-stage model 61, however, does not include a fully-connected layer that loses the adjacency information among pixels or feature values. The early-stage model 61 receives the image data 41. For example, the image data 41 has a size of 300 rows and 450 columns. The pixels of the image data 41 are identified by the coordinates of a rectangular coordinate system with row numbers and column numbers.

The early-stage model 61 processes the image data 41 to generate a feature map 45. The feature map 45 is a tensor in which feature values are arranged in a grid, and may include a plurality of channels in the depth direction. The feature values of the feature map 45 are identified by the coordinates of a rectangular coordinate system with row numbers and column numbers. In general, the feature map 45 is smaller in size than the image data 41. The early-stage model 61 corresponds to the above-described early-stage models 53 and 55.

A later-stage model 62 is a machine learning model for the human detection. The later-stage model 62 is a neural network, or may be a convolutional neural network with convolutional layers and pooling layers. The later-stage model 62 may include a fully-connected layer that loses the adjacency information among feature values. The later-stage model 62 generates positional information 42 from the feature map 45. The later-stage model 62 corresponds to the above-described later-stage model 54.

When the positional information 42 has been generated, feature values corresponding to an image region indicated by the positional information 42 are extracted from the feature map 45 on the basis of a coordinate transformation function, and then a partial feature map 46 is generated. The coordinate transformation function is created, taking into account the model structure of the early-stage model 61, and represents the mapping between the coordinates of the image data 41 and the coordinates of the feature map 45. In this connection, the partial feature map 46 may be modified to match the input format of a later-stage model 63. For example, the size of the partial feature map 46 is enlarged or reduced to match the input size for the later-stage model 63.

The later-stage model 63 is a machine learning model for the pose estimation. The later-stage model 63 is a neural network, or may be a convolutional neural network. The later-stage model 63 may include a fully-connected layer. The later-stage model 63 may include the same model structure as the later-stage model 62 or may include a model structure different from that of the later-stage model 62. Note that, since the later-stage models 62 and 63 have different inference purposes, these models 62 and 63 are trained independently and include different parameter values. The later-stage model 63 generates pose information 44 from the partial feature map 46. The later-stage model 63 corresponds to the above-described later-stage model 56.

In the second embodiment, the early-stage model 61 is executed at the edge server 32, whereas the later-stage models 62 and 63 are executed at the cloud server 33. Therefore, the feature map 45 is sent from the edge server 32 to the cloud server 33. In addition, the coordinate transformation function is stored in the edge server 32. Therefore, the coordinate transformation function is sent from the edge server 32 to the cloud server 33 before the cloud server 33 starts to process image data obtained by the surveillance camera 31. In this connection, the early-stage model 61 may be executed at the cloud server 33. In addition, at least one of the later-stage models 62 and 63 may be executed at the edge server 32.

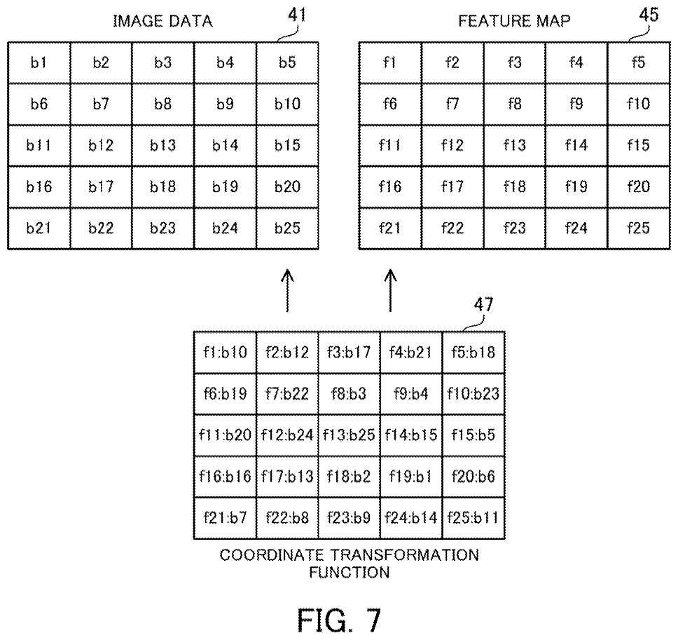

FIG. 7 illustrates an example of the coordinate transformation function.

The coordinate transformation function 47 represents the mapping between the coordinates of the image data 41 and the coordinates of the feature map 45. The coordinate transformation function 47 is created by a user with reference to the model structure of the early-stage model 61, and is stored in the edge server 32. In this connection, the coordinate transformation function 47 may be automatically created on the basis of the model structure of the early-stage model 61.

The image data 41 is divided into a plurality of image blocks of the same size. Each image block is a rectangular region with a fixed number of pixels. The feature map 45 is divided into a plurality of feature blocks of the same size. Each feature block is a rectangular region with a fixed number of feature values. The number of image blocks and the number of feature blocks are the same. The coordinate transformation function 47 provides one-to-one mapping between the plurality of image blocks of the image data 41 and the plurality of feature blocks of the feature map 45. That is, one image block does not correspond to two or more feature blocks, and one feature block does not correspond to two or more image blocks.

In the case where the feature map 45 is similar to the image data 41, the number of feature blocks arranged in the height direction in the feature map 45 is the same as the number of image blocks arranged in the height direction in the image data 41. In addition, the number of feature blocks arranged in the width direction in the feature map 45 is the same as the number of image blocks arranged in the width direction in the image data 41. In the case where the feature map 45 is smaller than the image data 41, a feature block is smaller in size than an image block, i.e., the number of feature values included in a feature block is smaller than the number of pixels included in an image block.

The number of image blocks and the number of feature blocks are determined in advance. The coordinates of the pixels included in an image block may be computed based on the position of the image block in the image data 41 and the size of one image block. In addition, the coordinates of the feature values included in a feature block may be computed based on the position of the feature block in the feature map 45 and the size of one feature block.

In the case where the early-stage model 61 does not rearrange the image blocks or feature blocks, the mutual positional relationship between the plurality of image blocks and the plurality of feature blocks are kept. In the case where the early-stage model 61 is a convolutional neural network with only convolutional layers and pooling layers, such positional relationship is kept. For example, the upper left feature block f1 in the feature map 45 corresponds to the upper left image block b1 in the image data 41. In addition, the feature block f2 directly on the right side of the feature block f1 corresponds to the image block b2 directly on the right side of the image block b1. In addition, the feature block f6 directly under the feature block f1 corresponds to the image block b6 directly under the image block b1.

However, in the case where the early-stage model 61 rearranges the image blocks or feature blocks as will be described later, the above-described positional relationship is not kept. Referring to the example of FIG. 7, the feature block f1 corresponds to the image block b10, the feature block f2 corresponds to the image block b12, and the feature block f6 corresponds to the image block b19. In addition, the image block b13 corresponds to the feature block f17, the image block b18 corresponds to the feature block f5, and the image block b23 corresponds to the feature block f10.

The cloud server 33 selects an image region from the image data 41 on an image-block basis, and extracts feature values from the feature map 45 on a feature-block basis. When the later-stage model 62 has specified a bounding box, the cloud server 33 selects image blocks overlapping the bounding box and image blocks located inside the boundary box from the image data 41. The cloud server 33 specifies feature blocks corresponding to the selected image blocks on the basis of the coordinate transformation function 47, and extracts the specified feature blocks from the feature map 45.

For example, the later-stage model 62 specifies, as an image region including a human, a bounding box that overlaps the image blocks b13, b18, and b23. After that, the cloud server 33 compares the coordinates of the bounding box with the coordinates of each image block to select the image blocks b13, b18, and b23 from the image data 41. The cloud server 33 specifies feature blocks f5, f10, and f17 corresponding to the image blocks b13, b18, and b23 with reference to the coordinate transformation function 47, and extracts the feature blocks f5, f10, and f17 from the feature map 45. The cloud server 33 arranges the feature blocks f5, f10, and f17 in keeping with the arrangement of the image blocks b13, b18, and b23 to generate a partial feature map 46.

The following describes the model structure of the early-stage model 61, based on which the coordinate transformation function 47 is created. The early-stage model 61 may include pooling layers and convolutional layers. The pooling layers and convolutional layers keep the tensor structure of a feature map. The early-stage model 61, however, does not include a fully-connected layer. The fully-connected layer loses the tensor structure of the feature map. In this connection, the early-stage model 61 may perform “patching” of rearranging image blocks or feature blocks. In the case where the patching is not performed, the feature map 45 is similar to the image data 41, and the relative positions of the feature blocks are identical to those of the image blocks. In the case where the patching is performed, the feature map 45 is not similar to the image data 41, and thus the relative positions of the feature blocks are not identical to those of the image blocks.

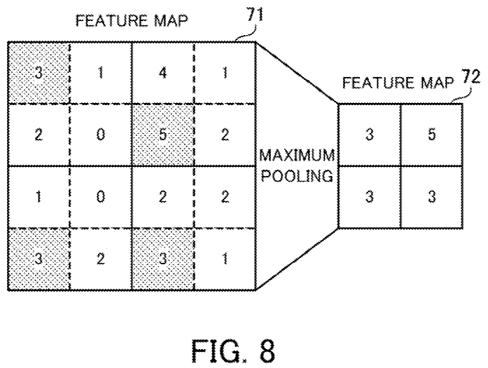

FIG. 8 illustrates an example of data transformation in a pooling layer.

The pooling layer transforms a feature map 71 to a feature map 72. The feature map 71 includes 16 (=4×4) feature values. The pooling layer transforms a small rectangular region of size 2×2, 3×3, or another in the feature map 71 to one feature value of the feature map 72. In the case of size 2×2, the length of one side of the feature map 72 is half of that of the feature map 71. In the case of size 3×3, the length of one side of the feature map 72 is one-third of that of the feature map 71.

Pooling operations include maximum pooling and average pooling. The maximum pooling is a pooling operation that selects the maximum value from the feature values included in a small region. The average pooling is a pooling operation that computes the average value of the feature values included in a small region. Referring to the example of FIG. 8, the pooling layer performs the maximum pooling for size 2×2.

The pooling layer selects the maximum value from the feature values at the coordinates (0, 0), (0, 1), (1, 0), and (1, 1) included in the feature map 71, and takes the maximum value as the feature value at the coordinate (0, 0) of the feature map 72. In addition, the pooling layer selects the maximum value from the feature values at the coordinates (0, 2), (0, 3), (1, 2), and (1, 3) included in the feature map 71, and takes the maximum value as the feature value at the coordinate (0, 1) of the feature map 72. In addition, the pooling layer selects the maximum value from the feature values at the coordinates (2, 0), (2, 1), (3, 0), and (3, 1) included in the feature map 71, and takes the maximum value as the feature value at the coordinate (1, 0) of the feature map 72. In addition, the pooling layer selects the maximum value from the feature values at the coordinates (2, 2), (2, 3), (3, 2), and (3, 3) included in the feature map 71, and takes the maximum value as the feature value at the coordinate (1,1) of the feature map 72.

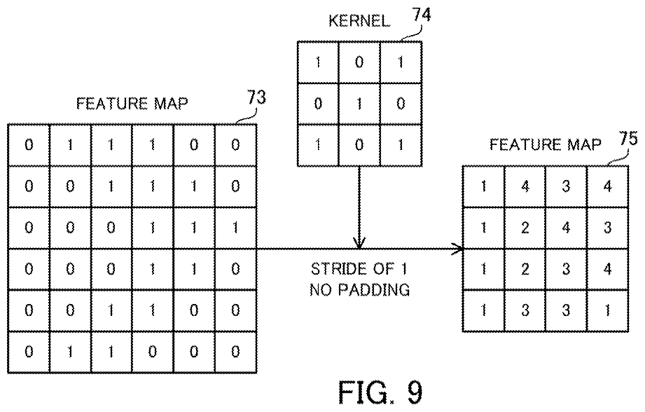

FIG. 9 illustrates an example of data transformation in a convolutional layer.

A convolutional layer transforms a feature map 73 to a feature map 75 using a kernel 74. The feature map 73 includes 36 (=6×6) feature values. The kernel 74 is a coefficient matrix of size 3×3, 5×5, or another. The coefficients included in the kernel 74 are parameters trained by machine learning. The convolutional layer superimposes the kernel 74 onto the feature map 73, and performs a multiply-add operation that computes the products of each feature value of the feature map 73 and a coefficient of the kernel 74 that overlap each other and adds the products. The result of the multiply-add operation is taken as one feature value of the feature map 75. The convolutional layer repeats the multiply-add operation while shifting the kernel 74 on the feature map 73 “stride” by “stride.” The stride is one, two, or three, for example.

In the case where the stride is one, the length of one side of the feature map 75 is a value obtained by subtracting the length of one side of the kernel 74 from the length of one side of the feature map 73 and adding one to the subtraction result. Note that the convolutional layer may perform padding to add pads around the feature map 73 so that the feature map 75 has the same size as the feature map 73. In the case where the stride is two, the length of one side of the feature map 75 is approximately half of that of the feature map 73. In the case where the stride is three, the length of one side of the feature map 75 is approximately one-third of that of the feature map 73.

FIG. 9 exemplifies the case where the stride is one and no padding is performed. For example, a convolutional layer computes the feature value at the coordinate (0, 0) of the feature map 75 on the basis of a region of size 3×3 specified by the coordinates (0, 0) and (2, 2) of the feature map 73 and the kernel 74. Further, the convolutional layer computes the feature value at the coordinate (0, 1) of the feature map 75 on the basis of a region of size 3×3 specified by the coordinates (0, 1) and (2, 3) of the feature map 73 and the kernel 74. Still further, the convolutional layer computes the feature value at the coordinate (1, 0) of the feature map 75 on the basis of a region of size 3×3 specified by the coordinates (1, 0) and (3, 2) of the feature map 73 and the kernel 74.

The convolutional layer may apply different kernels to the same feature map to generate a multichannel feature map. By doing so, a feature map to be output may have more channels than a feature map received.

A machine learning model called visual geometry group 16 (VGG 16) includes a plurality of convolutional layers and a plurality of pooling layers. VGG 16 includes some fully-connected layers at the end, but does not include any fully-connected layer before that. Therefore, it is possible to use a part of the VGG 16 before the fully-connected layers as the early-stage model 61.

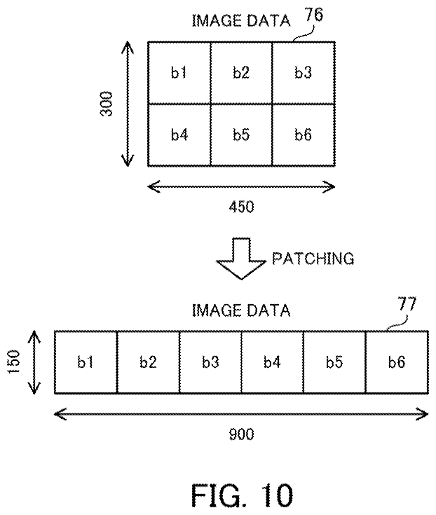

FIG. 10 illustrates an example of rearranging image blocks.

A certain early-stage model may perform patching of rearranging a plurality of image blocks or a plurality of feature blocks in a fixed manner. For example, the early-stage model divides image data 76 of size 300×450 into image blocks b1, b2, b3, b4, b5, and b6 of size 150×150. The early-stage model arranges the image blocks b1, b2, b3, b4, b5, and b6 in a sequential manner to thereby generate image data 77 of size 150×900. The early-stage model generates a feature map similar to the image data 77, through neural network layers such as convolutional layers and pooling layers.

Even in the case where the plurality of image blocks or the plurality of feature blocks are rearranged, the tensor structure of each individual feature block is kept, and the practice of computing one feature value on the basis of a small number of adjacent pixel values is kept. Therefore, the one-to-one relationship between feature blocks and image blocks is kept. This allows the early-stage model to perform the patching.

A machine learning model called detection transformer (DETR) linearizes a feature map output from a convolutional neural network and inputs the linearization result to a transformer encoder. DETR rearranges an n×m feature vector in a two-dimensional array to a 1×nm feature vector in a linear array. As in DETR, the early-stage model is allowed to internally rearrange a plurality of feature blocks.

The following describes an example of the early-stage model 61 and later-stage models 62 and 63.

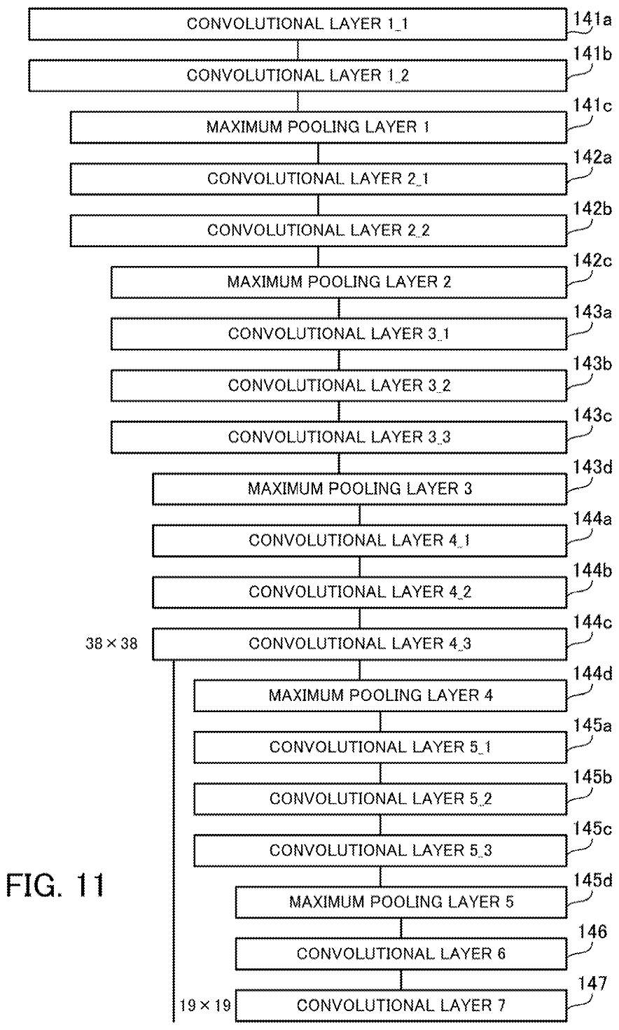

FIG. 11 illustrates an example of the structure of an early-stage model.

The following describes, as an example, the case where the first half of a machine learning model called single shot multibox detector (SSD) is used as the early-stage model 61, and the second half of the SSD is used as the later-stage models 62 and 63. The early-stage model 61 corresponds to an SSD-based network, and the later-stage models 62 and 63 correspond to additional feature layers of the SSD. The later-stage models 62 and 63 have the same model structure. However, the later-stage model 62 is trained for the human detection, whereas the later-stage model 63 is trained for the pose estimation. Therefore, the later-stage models 62 and 63 have different parameter values.

The early-stage model 61 includes convolutional layers 141a, 141b, 142a, 142b, 143a, 143b, 143c, 144a, 144b, 144c, 145a, 145b, 145c, 146, and 147. In addition, the early-stage 28S model 61 includes maximum pooling layers 141c, 142c, 143d, 144d, and 145d.

The convolutional layer 141a receives the image data 41 and transforms the image data 41 to a feature map with a convolution operation. The convolutional layer 141b transforms the feature map generated by the convolutional layer 141a to a different feature map with the convolution operation. The maximum pooling layer 141c transforms the feature map generated by the convolutional layer 141b to a different feature map with the maximum pooling. The convolutional layer 142a transforms the feature map generated by the maximum pooling layer 141c to a different feature map with the convolution operation. The convolutional layer 142b transforms the feature map generated by the convolutional layer 142a to a different feature map with the convolution operation. The maximum pooling layer 142c transforms the feature map generated by the convolutional layer 142b to a different feature map with the maximum pooling.

The convolutional layer 143a transforms the feature map generated by the maximum pooling layer 142c to a different feature map with the convolution operation. The convolutional layer 143b transforms the feature map generated by the convolutional layer 143a to a different feature map with the convolution operation. The convolutional layer 143c transforms the feature map generated by the convolutional layer 143b to a different feature map with the convolution operation. The maximum pooling layer 143d transforms the feature map generated by the convolutional layer 143c to a different feature map with the maximum pooling.

The convolutional layer 144a transforms the feature map generated by the maximum pooling layer 143d to a different feature map with the convolution operation. The convolutional layer 144b transforms the feature map generated by the convolutional layer 144a to a different feature map with the convolution operation. The convolutional layer 144c transforms the feature map generated by the convolutional layer 144b to a different feature map with the convolution operation. The convolutional layer 144c outputs the feature map of size 38×38. The maximum pooling layer 144d transforms the feature map generated by the convolutional layer 144c to a different feature map with the maximum pooling.

The convolutional layer 145a transforms the feature map generated by the maximum pooling layer 144d to a different feature map with the convolution operation. The convolutional layer 145b transforms the feature map generated by the convolutional layer 145a to a different feature map with the convolution operation. The convolutional layer 145c transforms the feature map generated by the convolutional layer 145b to a different feature map with the convolution operation. The maximum pooling layer 145d transforms the feature map generated by the convolutional layer 145c to a different feature map with the maximum pooling.

The convolutional layer 146 transforms the feature map generated by the maximum pooling layer 145d to a different feature map with the convolution operation. The convolutional layer 147 transforms the feature map generated by the convolutional layer 146 to a different feature map with the convolution operation. The convolutional layer 147 outputs the feature map of size 19×19. The early-stage model 61 outputs the feature map of size 38×38 generated by the convolutional layer 144c and the feature map of size 19×19 generated by the convolutional layer 147.

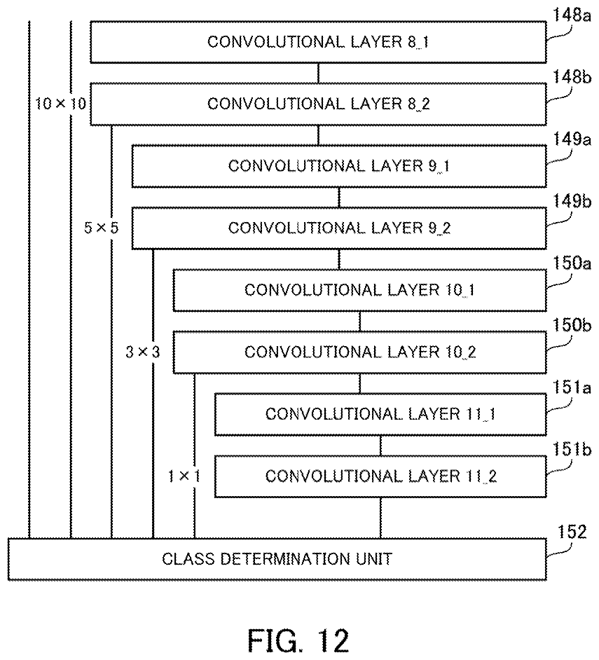

FIG. 12 illustrates an example of the structure of a later-stage model.

The later-stage model 62 includes convolutional layers 148a, 148b, 149a, 149b, 150a, 150b, 151a, and 151b and a class determination unit 152. The later-stage model 62 may include one or more pooling layers between these convolutional layers. The later-stage model 63 may have the same model structure as the later-stage model 62.

The convolutional layer 148a receives the feature map output from the convolutional layer 147 and transforms the feature map to a different feature map with the convolution operation. Here, a part of the feature map output from the convolutional layer 147 is input to the later-stage model 63. The convolutional layer 148b transforms the feature map generated by the convolutional layer 148a to a different feature map with the convolution operation. The convolutional layer 148b outputs the feature map of size 10×10. The convolutional layer 149a transforms the feature map generated by the convolutional layer 148b to a different feature map with the convolution operation. The convolutional layer 149b transforms the feature map generated by the convolutional layer 149a to a different feature map with the convolution operation. The convolutional layer 149b outputs the feature map of size 5×5.

The convolutional layer 150a transforms the feature map generated by the convolutional layer 149b to a different feature map with the convolution operation. The convolutional layer 150b transforms the feature map generated by the convolutional layer 150a to a different feature map with the convolution operation. The convolutional layer 150b outputs the feature map of size 3×3. The convolutional layer 151a transforms the feature map generated by the convolutional layer 150b to a different feature map with the convolution operation. The convolutional layer 151b transforms the feature map generated by the convolutional layer 151a to a different feature map with the convolution operation. The convolutional layer 151b outputs the feature map of size 1×1.

The class determination unit 152 obtains the feature maps of different sizes output from the convolutional layers 144c, 147, 148b, 149b, 150b, and 151b. Here, a part of each feature map output from the convolutional layers 144c and 147 is input to the later-stage model 63. The class determination unit 152 computes the probability of each of the plurality of classes using the received feature maps. The class determination unit 152 may include one or more fully-connected layers.

In the case of the later-stage model 62, the class determination unit 152 computes a probability with respect to each of the plurality of bounding box candidates of different sizes. Then, for example, a bounding box whose probability exceeds a threshold is determined to be a bounding box enclosing a human, and the coordinates of the bounding box are output. In the case of the later-stage model 63, the class determination unit 152 computes a probability with respect to each of the plurality of pose candidates. Then, for example, a pose whose probability exceeds a threshold is selected.

The early-stage model 61 and later-stage models 62 and 63 are trained by machine learning using training data. In the following description, it is assumed that the cloud server 34 performs the machine learning, deploys the early-stage model 61 in the edge server 32, and deploys the later-stage models 62 and 63 in the cloud server 33. Another information processing apparatus may perform the machine learning.

The cloud server 34 obtains a plurality of combinations each including image data, positional information indicating a correct bounding box, and pose information indicating a correct pose. The image data corresponds to input data, and the positional information and pose information correspond to teacher data. The cloud server 34 first tunes the early-stage model 61 and later-stage model 62, and thereafter tunes the later-stage model 63.

The cloud server 34 feeds the image data to the early-stage model 61 to thereby generate a feature map, and then feeds the feature map to the later-stage model 62 to thereby infer positional information. The cloud server 34 computes an error between the inferred positional information and the correct positional information, and updates the parameter values included in the early-stage model 61 and later-stage model 62 with an error backpropagation method. The cloud server 34 repeatedly feeds image data and updates the parameter values so as to optimize the parameter values of the early-stage model 61 and later-stage model 62. By doing so, the early-stage model 61 and later-stage model 62 are tuned so as to detect an image region including a human in image data.

Then, the cloud server 34 feeds the image data to the trained early-stage model 61 to thereby generate a feature map. The cloud server 34 feeds the feature map to the later-stage model 63 to thereby infer pose information. The cloud server 34 computes an error between the inferred pose information and the correct pose information, and updates the parameter values included in the later-stage model 63 with the error backpropagation method. The cloud server 34 repeatedly feeds a feature map and updates the parameter values so as to optimize the parameter values of the later-stage model 63. By doing so, the later-stage model 63 is tuned so as to estimate a human pose, assuming outputs of the trained early-stage model 61. Note that the above machine learning procedure is just an example, and another procedure may be taken for the machine learning.

The following describes the functions of the edge server 32 and cloud servers 33 and 34.

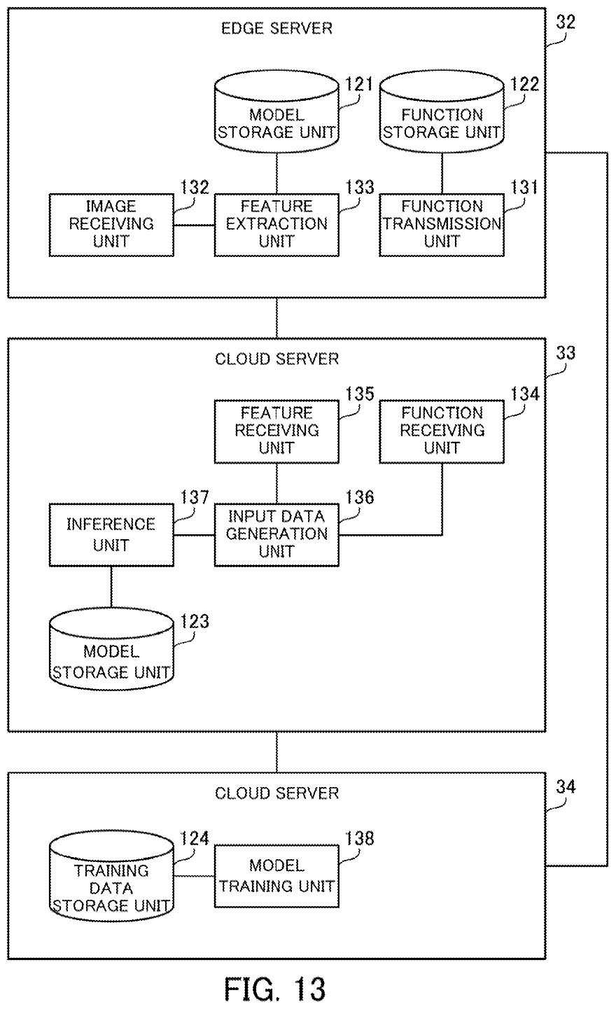

FIG. 13 is a block diagram illustrating an example of the functions of server apparatuses.

The edge server 32 includes a model storage unit 121, a function storage unit 122, a function transmission unit 131, an image receiving unit 132, and a feature extraction unit 133. The model storage unit 121 and function storage unit 122 are implemented by using a RAM or HDD, for example. The function transmission unit 131, image receiving unit 132, and feature extraction unit 133 are implemented by using a CPU or GPU, programs, and a communication interface, for example.

The model storage unit 121 stores therein the trained early-stage model 61. The early-stage model 61 may be stored in the edge server 32 by the user or may be transferred thereto from another information processing apparatus. The function storage unit 122 stores therein the coordinate transformation function 47. The coordinate transformation function 47 may be stored in the edge server 32 by the user or may be transferred thereto from another information processing apparatus.

When a cloud server that is to analyze image data obtained by the surveillance camera 31 has been determined, the function transmission unit 131 sends the coordinate transformation function 47 stored in the function storage unit 122 to the determined cloud server before the cloud server starts to analyze the image data. It is now assumed that the function transmission unit 131 sends the coordinate transformation function 47 to the cloud server 33.

The image receiving unit 132 continuously receives image data from the surveillance camera 31. For example, the image receiving unit 132 receives image frames at a fixed frame rate from the surveillance camera 31. The feature extraction unit 133 feeds the image data received by the image receiving unit 132 to the early-stage model 61 stored in the model storage unit 121, to thereby generate a feature map. The feature extraction unit 133 sends the generated feature map to the cloud server 33.

The cloud server 33 includes a model storage unit 123, a function receiving unit 134, a feature receiving unit 135, an input data generation unit 136, and an inference unit 137. The model storage unit 123 is implemented by using the RAM 102 or HDD 103, for example. The function receiving unit 134, feature receiving unit 135, input data generation unit 136, and inference unit 137 are implemented by using a CPU or GPU, programs, and a communication interface, for example.

The model storage unit 123 stores therein the trained later-stage models 62 and 63. The later-stage models 62 and 63 may be stored in the cloud server 33 by the user or may be transferred to the cloud server 33 from another information processing apparatus.

The function receiving unit 134 receives the coordinate transformation function 47 from the edge server 32 before the analysis of image data starts. The function receiving unit 134 stores the received coordinate transformation function 47 in a volatile memory device such as the RAM 102 or a non-volatile storage device such as the HDD 103. The feature receiving unit 135 continuously receives feature maps from the edge server 32. For example, the feature receiving unit 135 receives feature maps corresponding to image frames at a fixed frame rate.

The input data generation unit 136 generates input data to be fed to each of the later-stage models 62 and 63 on the basis of a feature map received by the feature receiving unit 135. The input data to be fed to the later-stage model 62 is the feature map itself received from the edge server 32. The input data to be fed to the later-stage model 63 is feature blocks corresponding to image blocks containing an image region detected by the later-stage model 62, in the feature map received from the edge server 32. The feature blocks corresponding to the image blocks containing the image region including a human are specified using the coordinate transformation function 47 received by the function receiving unit 134.

The inference unit 137 performs the human detection and pose estimation using the later-stage models 62 and 63 stored in the model storage unit 123. The inference unit 137 feeds the input data generated by the input data generation unit 136 to the later-stage model 62 to thereby generate positional information 42 indicating an image region including a human. When the positional information 42 has been generated, the inference unit 137 feeds the input data generated by the input data generation unit 136 to the later-stage model 63 to thereby generate pose information 44 indicating the pose of the human. The inference unit 137 outputs the positional information 42 and pose information 44. The inference unit 137 may store the positional information 42 and pose information 44 in a non-volatile storage, may display them on the display device 111, or may send them to another information processing apparatus.

The cloud server 34 includes a training data storage unit 124 and a model training unit 138. The training data storage unit 124 is implemented by using an RAM or HDD, for example. The model training unit 138 is implemented by using a CPU or GPU, and programs, for example.

The training data storage unit 124 stores therein a plurality of image data used for the machine learning. Each image data is given correct positional information and correct pose information. The correct positional information and correct pose information are given by the user, for example.

The model training unit 138 trains the early-stage model 61 and later-stage models 62 and 63 using the image data stored in the training data storage unit 124. First, the model training unit 138 trains the early-stage model 61 and later-stage model 62 so that positional information is inferred from image data. By doing so, the later-stage model 62 is tuned so as to detect an image region including a human. After that, the model training unit 138 trains the later-stage model 63 so that pose information is inferred from a feature map generated by the trained early-stage model 61. By doing so, the later-stage model 63 is tuned so as to estimate the pose of a human.

The model training unit 138 outputs the trained early-stage model 61 and later-stage models 62 and 63. The model training unit 138 may store the early-stage model 61 and later-stage models 62 and 63 in a non-volatile storage device, may display them on a display device, or may send them to another information processing apparatus. For example, the model training unit 138 sends the early-stage model 61 to the edge server 32 and sends the later-stage models 62 and 63 to the cloud server 33.

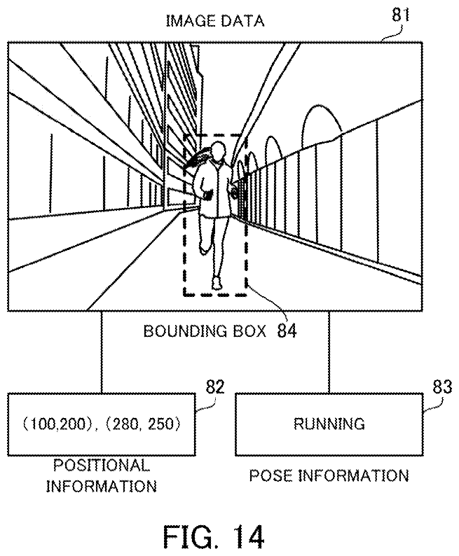

FIG. 14 illustrates an example of machine learning data.

The training data storage unit 124 stores therein image data 81. In addition, the training data storage unit 124 stores therein positional information 82 and pose information 83 in association with the image data 81. The positional information 82 indicates the coordinates of a bounding box 84 enclosing an image region including a human. For example, the positional information 82 indicates the upper left coordinate and lower right coordinate of the bounding box 84. The pose information 83 indicates the pose of the human included in the bounding box 84.

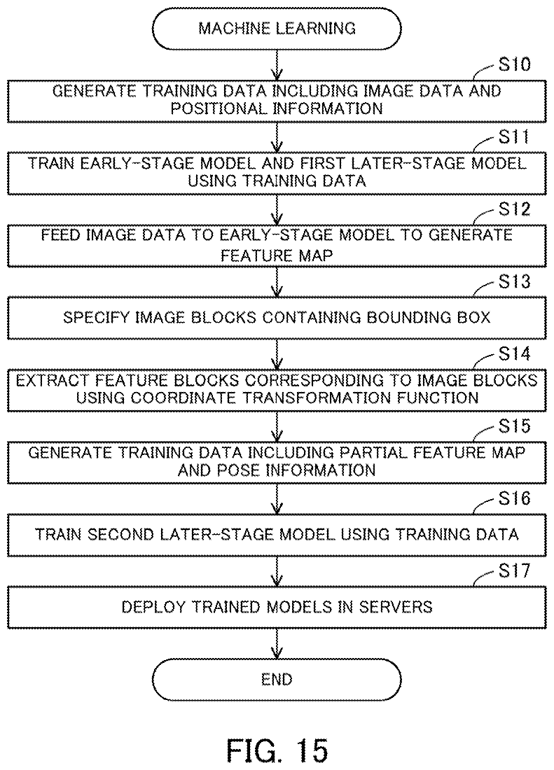

FIG. 15 is a flowchart illustrating an example of a machine learning procedure.

(S10) The model training unit 138 reads image data and positional information indicating a correct bounding box from the training data storage unit 124, and generates a data set including a plurality of combinations each including image data and positional information as training data for the human detection.

(S11) The model training unit 138 trains an early-stage model and a first later-stage model using the training data of step S10. At this time, the model training unit 138 feeds the image data to the early-stage model to thereby generate a feature map, and feeds the feature map to the first later-stage model to thereby estimate positional information. The model training unit 138 computes an error between the estimated positional information and the correct positional information, and updates the parameter values of the early-stage model and first later-stage model so as to reduce the error.

(S12) The model training unit 138 feeds the image data included in the training data of step S10 to the trained early-stage model to thereby generate a feature map.

(S13) The model training unit 138 specifies image blocks containing a bounding box indicated by the positional information included in the training data of step S10 in the image data.

(S14) The model training unit 138 extracts feature blocks corresponding to the image blocks of step S13 from the feature map of step S12 using the coordinate transformation function, and generates a partial feature map in which the extracted feature blocks are arranged. At this time, the model training unit 138 may deform the partial feature map to match the input format of a second later-stage model.

(S15) The model training unit 138 reads the pose information indicating a correct pose from the training data storage unit 124, and generates a data set including a plurality of combinations each including a partial feature map of step S14 and pose information, as training data for the pose estimation.

(S16) The model training unit 138 trains the second later-stage model using the training data of step S15. At this time, the model training unit 138 feeds the partial feature map to the second later-stage model to thereby estimate pose information. The model training unit 138 computes an error between the estimated pose information and the correct pose information, and updates the parameter values of the second later-stage model so as to reduce the error.

(S17) The model training unit 138 outputs the trained early-stage model, first later-stage model, and second later-stage model. For example, the model training unit 138 deploys the early-stage model in the edge server 32, and deploys the first later-stage model and second later-stage model in the cloud server 33. The model training unit 138 may store the trained early-stage model, first later-stage model, and second later-stage model in a non-volatile storage device, may display them on a display device, or may send them to an information processing apparatus other than the edge server 32 and cloud server 33.

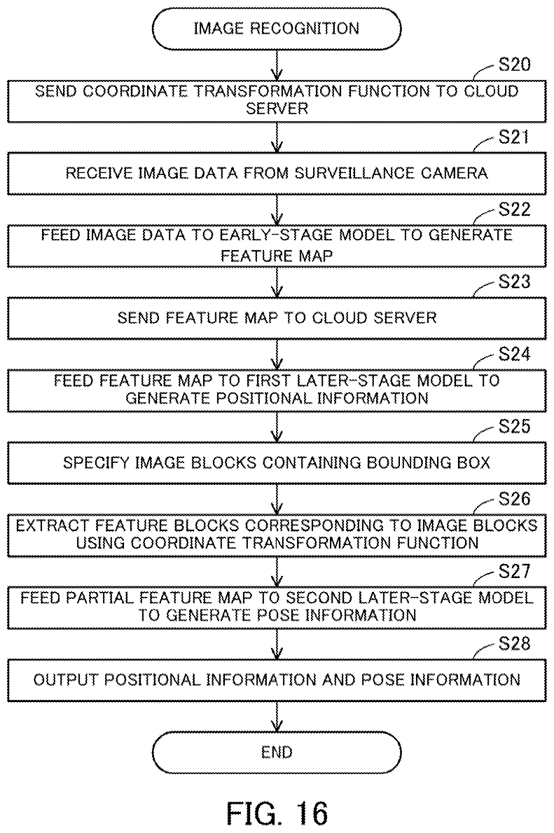

FIG. 16 is a flowchart illustrating an example of an image recognition procedure.

(S20) The function transmission unit 131 reads the coordinate transformation function from the function storage unit 122 and sends the coordinate transformation function to the cloud server 33. The function receiving unit 134 stores the received coordinate transformation function.

(S21) The image receiving unit 132 receives image data from the surveillance camera 31.

(S22) The feature extraction unit 133 feeds the image data to the early-stage model stored in the model storage unit 121 to thereby generate a feature map corresponding to the entire image data.

(S23) The feature extraction unit 133 sends the feature map to the cloud server 33.

(S24) The feature receiving unit 135 receives the feature map from the edge server 32. The inference unit 137 feeds the feature map to the first later-stage model stored in the model storage unit 123 to thereby generate positional information indicating a bounding box enclosing an image region including a human.

(S25) The input data generation unit 136 specifies image blocks containing a bounding box indicated by the positional information in the image data.

(S26) The input data generation unit 136 extracts feature blocks corresponding to the image blocks of step S25 from the feature map using the coordinate transformation function, and generates a partial feature map in which the extracted feature blocks are arranged. At this time, the input data generation unit 136 may deform the partial feature map so as to match the input format of the second later-stage model.

(S27) The inference unit 137 feeds the partial feature map to the second later-stage model stored in the model storage unit 123 to thereby generate pose information indicating the pose of the human included in the bounding box.

(S28) The inference unit 137 outputs the positional information of step S24 and the pose information of step S27. The inference unit 137 may store the positional information and pose information in a non-volatile storage device, may display them on a display device, or may send them to another information processing apparatus.

As described above, the information processing system of the second embodiment performs inference processes with different inference purposes on image data obtained by the surveillance camera 31 using a plurality of machine learning models. By doing so, multilateral analysis is conducted on the image data, which improves the analysis accuracy. In addition, the edge server 32 located near the surveillance camera 31 performs feature extraction from the image data, and a cloud server with high computing power performs the inference processes using the extracted feature values. Therefore, the information processing system is able to use various cloud servers for analysis of image data.

In addition, the information processing system uses a certain machine learning model to detect an image region including a human in image data, and then uses a different machine learning model to estimate the pose of the human included in the detected image region. Since the latter machine learning model performs an inference process on the image region obtained as a result of narrowing down the image data, the accuracy of the pose estimation is improved. In addition, the information processing system uses the early-stage model in common for both the human detection and the pose estimation, in order to reuse the feature values extracted in the human detection, for the pose estimation. This eliminates the need of performing feature extraction in the pose estimation, which reduces the computational complexity and the load.

In addition, the information processing system refers to the coordinate transformation function based on the model structure of the early-stage model to determine feature values that are reused in the pose estimation among the feature values extracted in the human detection. Therefore, appropriate feature values corresponding to a detected image region are reused. In addition, the information processing system tunes the early-stage model and first later-stage model so as to detect an image region including a human, and then assuming outputs of the trained early-stage model, tunes the second later-stage model so as to estimate the pose of the human. As a result, the generated early-stage model, first later-stage model, and second later-stage model have high quality, which improves the inference accuracy in the human detection and pose estimation.

According to one aspect, it is possible to reduce the computational complexity of a plurality of machine learning models that perform inference processes on different image regions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
obtaining first feature data generated from image data including a plurality of pixels given different first coordinates, the first feature data including a plurality of feature values given different second coordinates;
generating a first inference result indicating a partial image region of the image data by feeding the first feature data to a first machine learning model;
generating second feature data corresponding to the partial image region indicated by the first inference result, from the first feature data, based on coordinate mapping information indicating mapping between the different first coordinates and the different second coordinates; and
generating a second inference result for the partial image region by feeding the second feature data to a second machine learning model.

2. The non-transitory computer-readable storage medium according to claim 1, wherein the first feature data is generated by feeding the image data to a third machine learning model.

3. The non-transitory computer-readable storage medium according to claim 1, wherein the second feature data is generated by extracting feature values given second coordinates corresponding to the partial image region from the first feature data.

4. The non-transitory computer-readable storage medium according to claim 1, wherein
the first machine learning model infers an image region including an object that is a detection target from the image data, and
the second machine learning model infers a state of the object.

5. An inference method comprising:
obtaining, by a processor, first feature data generated from image data including a plurality of pixels given different first coordinates, the first feature data including a plurality of feature values given different second coordinates;
generating, by the processor, a first inference result indicating a partial image region of the image data by feeding the first feature data to a first machine learning model;
generating, by the processor, second feature data corresponding to the partial image region indicated by the first inference result, from the first feature data, based on coordinate mapping information indicating mapping between the different first coordinates and the different second coordinates; and
generating, by the processor, a second inference result for the partial image region by feeding the second feature data to a second machine learning model.

6. An information processing apparatus comprising:
a memory configured to store therein coordinate mapping information indicating mapping between different first coordinates and different second coordinates, the different first coordinate being given to a plurality of pixels included in image data, the different second coordinates being given to a plurality of feature values included in first feature data generated from the image data; and
a processor coupled to the memory and configured to
obtain the first feature data,
generate a first inference result indicating a partial image region of the image data by feeding the first feature data to a first machine learning model,
generate second feature data corresponding to the partial image region indicated by the first inference result, from the first feature data, based on the coordinate mapping information, and
generate a second inference result for the partial image region by feeding the second feature data to a second machine learning model.
